(19) United States
(12) Patent Application Publication
(10) Pub. No.: US 2002/0145523 A1
(43) Pub. Date: Oct. 10, 2002

(54) Device for controlling access of a unit, such as a water-closet

(76) Inventor: Jacques Robaey, Coudekerque Branche (FR)

Correspondence Address: Miles & Stockbridge, Suite 500, 1751 Pinnacle Drive, McLean, VA, 22102-3833, US

(21) Appl. No.: 10/103,870

(22) Filed: Mar. 25, 2002

Related U.S. Application Data
(63) Continuation of application No. 09/555,923, filed on Jun. 6, 2000, now abandoned.
Application No. 09/555,923 is a 371 of international application No. PCT/FR98/02623, filed on Dec. 4, 1998.

(30) Foreign Application Priority Data
Dec. 8, 1997 (FR) 97.15727

(51) Int. Cl. G08B 23/00

(52) U.S. Cl. 340/573.1; 340/541

(57) ABSTRACT

Device for controlling access to a unit, such as a water closet including: a wash basin with its tap, and a door controlling access of the room, and a device for deactivating a device associated with the unauthorized opening of the door in response to the maneuver of the tap, this device being characterized in that it includes: a device for first detecting the functioning of the tap, and second the presence of hands under the water jet of the tap.

The device concerns a device for controlling the access of a unit, such as a water-closet.

A water-closet normally includes:

a lavatory bowl,

wash basin with its tap, and

a door with its lock controlling entering and leaving the room.

Strict rules of hygiene are to be observed at all times and all the more so when these units are connected to sites for producing and/or preparing food products.

In the food industry and in particular in food preparation concerns, it is in fact necessary to establish a policy ensuring cleanliness and ensure that bacteria, microbes or other harmful germs do not proliferate.

This policy thus requires that employees wear a particular outfit and clean their shoes each time they enter a protected zone, etc.

So as to improve cleanliness, the sanitary blocks equipping these industries are generally provided in the close proximity with system taps for distributing antiseptic cleaning products and also technical means limiting the spreading of microbes.

The tap normally includes:

a body housing a obturator and

an obturator control device to move it between an open position and a closed position.

The obturator control device is generally a handle to be picked up by the hand of the user.

In hospitals, these handles are sometimes adapted so as to be no longer manipulated by hand, but by the front arm so that the surgeon, after having scrupulously washed his hands, can manoeuvre the tap without his hands coming into contact with the handle where microbes have been able to settle and proliferate.

Instead of a handle, control can also be effected by a pedal able to be activated by the foot of the individual.

This type of device is extensively used in the water-closets of railway carriages.

There are also taps in which manoeuvring the obturator can be made without any contact occurring.

To this effect, these taps include:

a device for detecting the presence of a portion of the human body immediately close to the tap, and

a motor device to control the manoeuvre of the obturator in response to this detection of this human body

These no-contact control means are increasingly equipping public washroom facilities and in particular urinals and thus avoid persons soiling their hands.

These particular measures are also accompanied with recommendations, such as the systematic washing of the hands after any contact with a soiled object or other item.

Unfortunately, it is known that a certain number of individuals do not systematically wash their filthy hands after having made use of urinals or WC bowls.

This can pose a serious problem in food concerns.

The document U.S. Pat. No. 4,896,144 describes an access control device in which, when the person needing to wash his hands does not activate the tap of the wash basin, a message is displayed asking him to use the wash basin.

However, this is not strictly an order.

One of the results the invention seeks to obtain is to provide a device of said type resolving drawbacks and to this effect concerns a device for controlling access of a room conventionally including:

a wash basin with its tap, and

a door controlling the access of the room,

a device for deactivating a device associated with the unauthorised opening of the door in response to manoeuvring the tap,

this control device being characterised in that it includes firstly a device for detecting functioning of the tap, and secondly the presence of hands under the water jet of the tap.

The invention shall be more readily understood from a reading of the following description given by way of non-restrictive example with reference to the accompanying drawing diagrammatically representing:

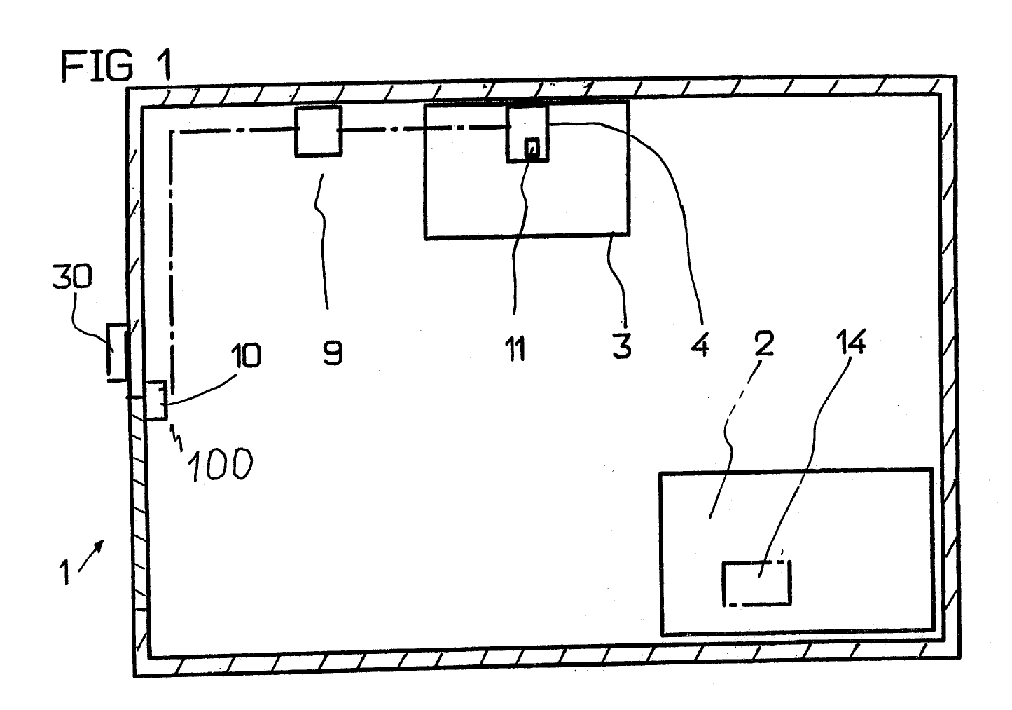

FIG. 1 : the equipment of a water closet,

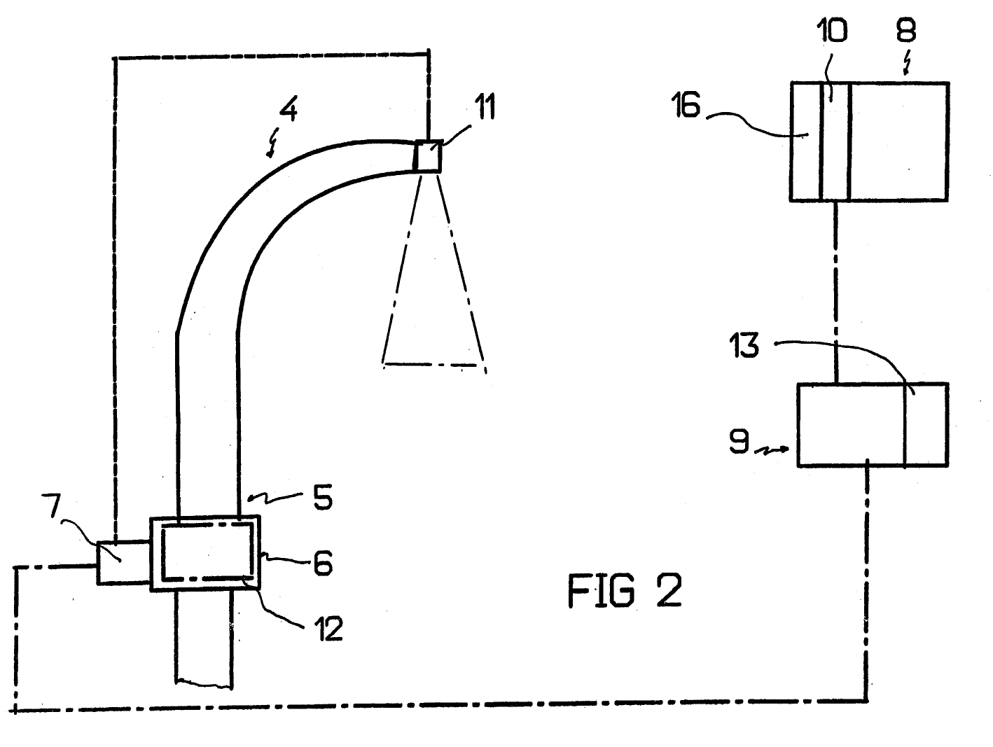

FIG. 2 : the control device,

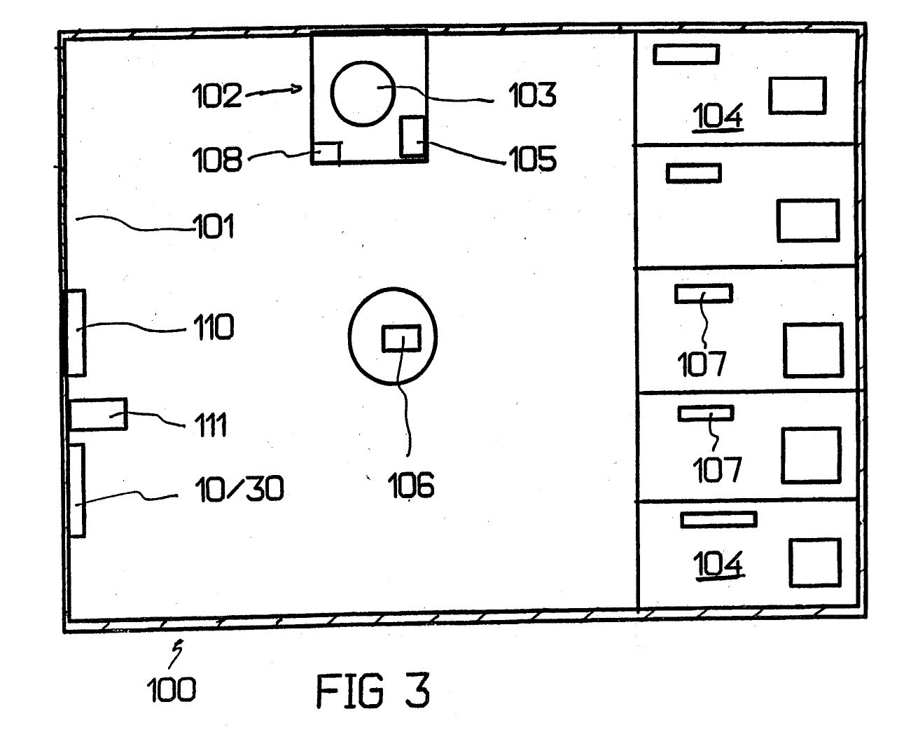

FIG. 3 : a water closet room.

The drawing shows the water closet 1 including a “WC” bowl 2, a urinal and a wash basin 3.

It further includes a device for controlling access of the room.

A door and its lock control access to the closet.

This wash basin is equipped with a tap 4.

This tap conventionally includes:

a body 5 housing an obturator 6, and

a device 7 for controlling the obturator so as to move it between an open position and a closed position, and

device 100 for deactivating a device 10/30 associated with the unauthorised opening of the door, such as a siren which is triggered when the door is re-opened without hands having been washed in response to manoeuvring the tap or a display system.

According to one characteristic of the invention, this control device includes a device 9 for detecting firstly the functioning of the tap, and secondly the presence of hands under the water jet of the tap.

In fact, it is important to check the presence of hands under the water jet.

According to another characteristic of the invention, the device includes:

a lock 8 with electric unlocking on the door, and

a device 10 for controlling unlocking of the door in response to the detection of the use of the tap in the presence of hands under the water jet.

The presence of hands under the water jet needs to be carried out for a minimum period.

These elements constitute the access control device.

Thus, when the hands are not washed, the door is unable to open or a verbal or luminous message is issued.

The detection device 9 includes a surveillance element 11 via the transmission or receiving an electromagnetic wave in a zone situated under the water jet.

For example, detection can be effected via a Doppler effect.

The tap includes a motor element 12 for manoeuvring the obturator in response to detection of this portion of the monitored human body.

A time counter 13 shall be provided on the system so as to demand that hands be washed at least during the time required and sufficient to eliminate microbes.

Deactivation of the lock or siren shall only be effected after the hands have been washed during the required time which shall for example be at least thirty seconds.

The following are preferably provided:

a system 14 for monitoring functioning of the bowl and

associated with this monitoring system a device 16 for controlling closing of the lock which can only be unlocked if hands have been washed for a minimum period.

A manual door unlocking system is provided to cater for emergency unlocking.

In certain cases, the concern has available several water closet units in a water closet room.

The water closet room 100 includes:

a main door 101,

at least one wash basin 102 and its tap 103, and

several water closet units 104 each closed by a secondary door.

In most cases, so as to guarantee that each person washes his hands, according to one characteristic of the invention, the device for controlling access of the water closet room includes:

on each wash basin, a device 105 for firstly detecting functioning of the tap, and secondly the effective presence of hands under the water jet,

an identification element 106 worn by each individual,

in each water closet unit, a device 107 for reading the identification element worn by the individual present,

on each wash basin a device 108 for reading the identification element worn by the individual in the process of washing his hands,

on the door of the water closet room, a device 110 for reading the identification element 106 worn by the individual appearing in front of the door for leaving, and

a device 111 for managing the various types of information originating from the reading devices for, after detection of the passage of the individual in the water closet unit and washing his hands and displaying the latter in front of the door of the room, authorising exit or, if authorisation is not given, sending him a reminder message.

The reading of the identifying label present on the identification element of the individual in front of the tap of the wash basin is preferably only validated when the individual has washed his hands during the time required.

1. Device for controlling the access of a unit, such as a water closet including:
wash basin (3) with its tap, and
a door controlling access of the room, and
a device (100) for deactivating a device (10/30) associated with the unauthorised opening of the door in response to the manoeuvre of the tap,
this device being characterised in that it includes:
a device (9) for firstly detecting the functioning of the tap, and secondly the presence of hands under the water jet of the tap.

2. Device according to claim 1, characterised in that it includes:
a lock (8) with electric unlocking on the door, and
a device (10) for controlling unlocking of the door in response to the detection of the use of the tap in the presence of hands under the water jet for a minimum period.

3. Device according to claim 1, characterised in that the detection device (9) includes a monitoring element (11) via the transmission/receiving of an electromagnetic wave in a zone situated under the water jets.

4. Device according to claim 1, characterised in that the tap includes a motor element (12) for manoeuvring the obturator in response to detection of the monitored portion of a human body.

5. Device according to claim 1, characterised in that a time counter (13) is provided on the system so as to oblige an individual wash his hands at least in the time required and sufficient to eliminate microbes.

6. Device according to claim 1, characterised in that it includes:
a system (14) for monitoring functioning of the bowl, and
associated with this monitoring system, a device (16) for controlling closing of the lock, said lock only being able to be unlocked provided that the hands of an individual have been washed for a minimum period.

7. Device according to claim 1, characterised in that it includes a manual stand-by unlocking system.

8. Device for controlling the access of a water closet room including:
a main door (101),
at least one wash basin (102) and its associated tap (103), and
several water closet units (104) each closed by a secondary door,
this device being characterised in that it includes:
on each wash basin, a device (105) for firstly detecting the functioning of the tap, and secondly the effective presence of hands under the water jet,
an identification element (106) worn by each individual,
in each water closet unit, a device (107) for reading the identification element worn by the individual present,
on each wash basin, a device (108) for reading the identification element worn by the individual in the process of washing his hands,
on the door of the water closet unit, a device (110) for reading the identification element (106) worn by the individual appearing in front of the door before leaving, and
a device (111) for managing the various elements of information originating from the reading devices for, after detection of the passage of the individual in the water closet unit, washing of his hands and appearing in front of the door of the room, authorising exit or sending him a reminder message.
